(19) United States
(12) Patent Application Publication
(10) Pub. No.: US 2012/0196492 A1
(43) Pub. Date: Aug. 2, 2012

(54) Clamp For Connection to the Poles of Electrical Battery

(75) Inventors: Danilo Facco, Vigodarzere (PD) (IT); Moreno Franco, Padova (IT); Francesco Artuso, Albignasego (PD) (IT)

(73) Assignee: VIEMME S.r.L., Limena (IT)

(21) Appl. No.: 13/497,202

(22) PCT Filed: Sep. 27, 2010
(86) PCT No.: PCT/IB10/02420

§ 371 Date: Apr. 17, 2012

(30) Foreign Application Priority Data
Sep. 28, 2009 (IT) VI2009A000235

(51) Int. Cl. H01R 4/38

(52) U.S. Cl. 439/765

(57) ABSTRACT

The invention is a battery terminal (1; 20; 30; 50) for electrical connections of the type comprising a substantially C-shaped body (2; 22; 42) suitable for coupling with the pole (P) of a battery; two parallel projecting laminate elements (3; 33) provided at the level of the open section (4) of the C-shaped to body (2; 42); tightening means (31; 51) associated with the laminate elements (3; 33) for clamping the shaped body (2; 22; 42) around the pole (P); connection means (9; 23) associated with the shaped body (2; 22; 42) for connection to the end of one or more electric wires. The tightening means (31; 51) comprise one pair of inclined planes (32) provided outside the laminate is elements (33), one pair of inclined counterplanes (34) in a fork-shaped body (35) and screw means (36; 56) for mutually forcing the inclined planes (32) and the inclined counterplanes (34).

The present invention concerns an improved terminal for connection to the poles of static batteries, for starting or traction applications.

As is known to the operators skilled in the art, special removable terminals are used to connect electrical equipment and devices to power supply batteries.

These are provided with means for tightening to the battery poles and means for connection to the terminals of the electrical wires that power the electrical to equipment.

A considerable drawback posed by the battery terminals of the known art lies in that the tightening means can be accessed only laterally with respect to the pole to which they are applied.

The space around the terminal is generally limited and such as to make it is difficult to access the tightening means from a lateral direction with respect to the direction defined by the longitudinal axis of the pole.

This happens, for example, when the battery lid is of the type provided with a protective housing suited to accommodate both the pole and the terminal when they are coupled together.

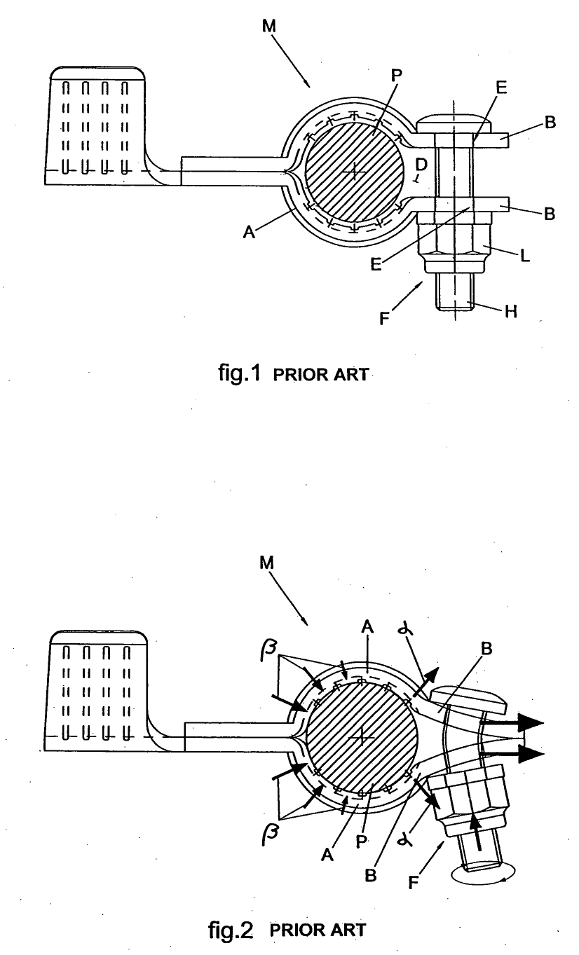

In particular, a battery terminal M of known type providing electrical connection to the pole P of a battery is shown in FIG. 1, where it can be observed that it comprises a C-shaped body, indicated as a whole by A, externally coupled with the pole P of the battery.

It is provided with two parallel laminate elements B at the level of the open section D of the shaped body A, which in turn are provided with through holes E housing means for tightening the terminal.

These comprise a bolt F comprising a screw H arranged so that it passes through the holes E, to which a closing nut L is coupled. The nut can be accessed only laterally and therefore poses the drawbacks mentioned above.

When the battery terminal M is open and thus arranged as shown in FIG. 1, the laminate elements B are sufficiently spaced, so that the C-shaped profile of the shaped body A is sufficiently wide to easily accommodate the pole P.

Once the coupling operation has been completed, the terminal M is secured to the pole P of the battery by tightening the bolt F.

A further drawback of the traditional terminals is clearly illustrated in FIG. 2 and occurs at the end of the tightening operation, when the C-shaped profile of the shaped body A tends to become elliptical as the laminate elements B, as shown, tend to be arranged obliquely with the ends in contact with each other.

This means that the screw H tends to bend and the inner surface of the shaped body A tends to detach from the outer surface of the pole P, especially at the level of the laminate elements B, as shown by the arrows α in FIG. 2.

Once the tightening operation has been completed, the pole P is thus in contact with one section only of the inner side surface of the C-shaped body, thus developing variable pressures that decrease nearer to the laminate elements B, as shown by the arrows β.

In proximity to the laminate elements B there is even a pressure inversion indicated by the change in the sense of the arrows α and β, because, as is already explained, the inner surface of the shaped body A tends to detach from the pole P.

It is evident that once the tightening operation has been completed the terminal and the tightening means are mechanically stressed in an anomalous way, and as regards current the terminal transmits a lower current compared to the current it could transmit if the contact conditions were optimal.

This involves, as a first drawback, the heating of the connection.

The second drawback lies in that there are energy losses resulting in lower efficiency.

The present invention aims to overcome the drawbacks listed above.

In particular, it is a first object of the invention to provide a battery terminal for electrical connections having easily accessible tightening means.

A further object of the invention is to provide a battery terminal with easily accessible tightening means that when clamped has a larger surface in contact with the battery pole to which it is applied than equivalent terminals of known type having the same dimensions.

It is a further object of the invention to provide a terminal that when tightened around the pole exerts a uniform and uniformly distributed pressure on the contact surface.

It is a further object of the invention to provide a terminal whose tightening means are not subjected to deformation.

The objects described above are achieved by a battery terminal for electrical connections whose characteristics are described in the main claim, to which the reader should refer for the sake of brevity.

The dependent claims describe other characteristics of the battery terminal that is the subject of the invention.

Advantageously, the battery terminal that is the subject of the invention is provided with tightening means that can be accessed from above.

Still advantageously, according to a construction variant the terminal of the invention can be provided with counteracting projections suited to cooperate by mutual contact when said tightening means lock said shaped body around said pole, having a larger surface in contact with the pole than terminals of known type having the same dimensions, and thus being capable of transmitting higher current density.

This allows for the further advantage of being able o transmit more power with is less heating.

According to a preferred construction variant of the invention, said counteracting projections are present in both said projecting laminate elements and are located at the end of said laminate elements. Once the two counteracting projections are in contact with each other, in particular if they have the same length, the two laminate elements can be moved nearer to each other by continuing the tightening operation, in a substantially symmetrical way, in the open section of the shaped body, thus increasing the perimeter contact between the pole and the shaped body.

The aims and advantages described above as well as other aims and advantages, if any, will be highlighted in greater detail in the description of a preferred embodiment of the invention that is supplied as an indicative, non-limiting example with reference to the enclosed drawings, wherein:

FIG. 1 shows a battery terminal for electrical connections of known type when open;

FIG. 2 shows the terminal of FIG. 1 when clamped;

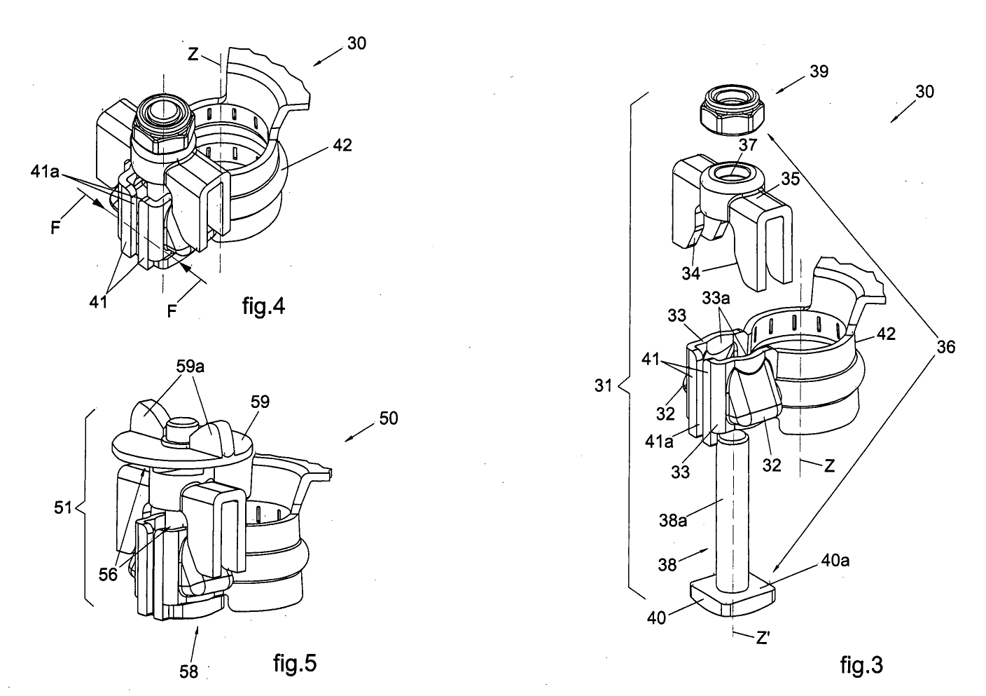

FIG. 3 shows a partial and exploded view of the terminal that is the subject of the invention;

FIG. 4 shows an axonometric view of the terminal of FIG. 3 when assembled;

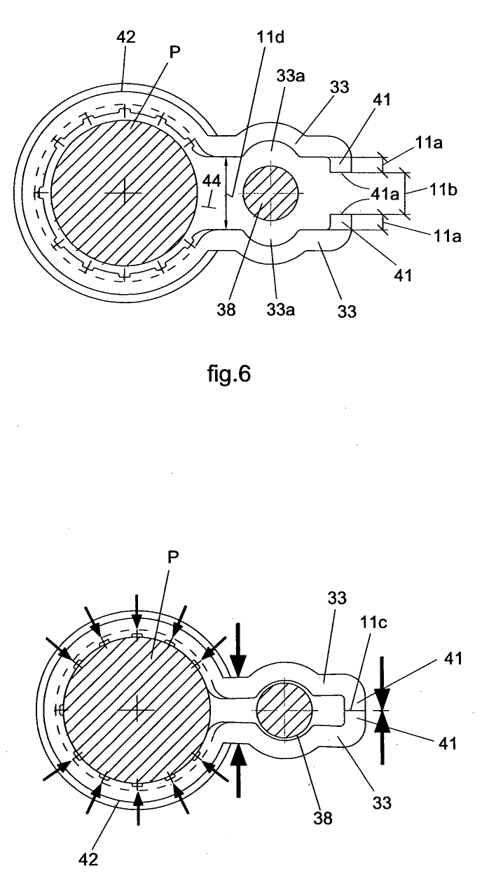

FIG. 5 shows a partial assembled view of another embodiment of the terminal of the invention;

FIG. 6 shows a top view of a detail of the terminal of the invention in open position;

FIG. 7 shows the detail of the terminal shown in FIG. 6 in clamped position;

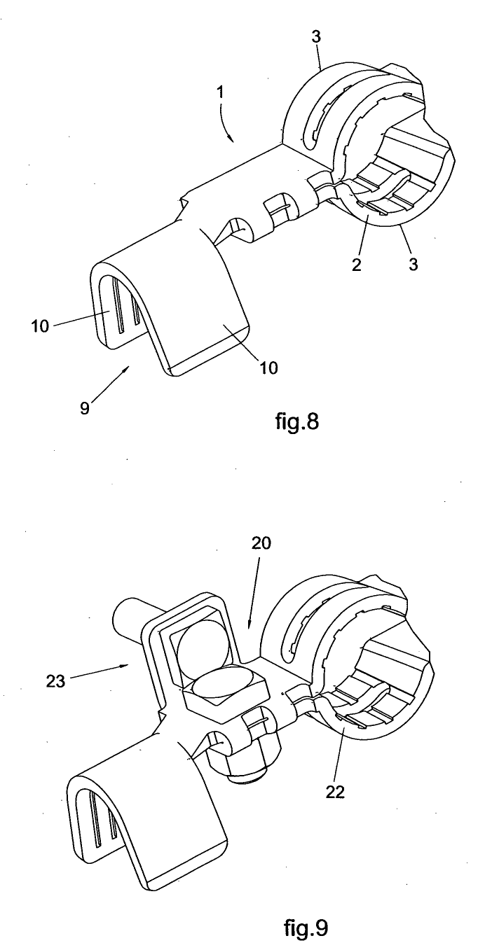

FIG. 8 shows an axonometric view of another example of embodiment of the connection means of the terminal constructed according to the invention;

FIG. 9 shows an axonometric view of a further example of embodiment of the connection means of the terminal of the invention.

A first construction variant of the invention is illustrated in FIGS. 3 and 4 where the terminal, indicated as a whole by 30, is provided with tightening is means 31 that can be accessed from above.

This embodiment is especially useful when the space around the terminal 30 is limited and such as to make it difficult to access the tightening means from a lateral direction with respect to the direction defined by the longitudinal axis Z of the pole P.

This happens, for example, when the battery lid is of the type provided with a protective housing suited to accommodate the pole P and also the terminal 30 when they are coupled together.

In these cases, the wall that delimits the housing prevents lateral access to the tightening means if these are made as described and illustrated.

The tightening means 31, with reference to FIG. 3, comprise one pair of inclined planes 32 provided outside the laminate elements 33, one pair of inclined counterplanes 34 in a fork-shaped body 35 and screw means for mutually forcing the inclined planes 32 and the inclined counterplanes 34.

As shown again in FIG. 3, the fork-shaped body 35 is provided with a through opening 37 arranged centrally with respect to the inclined counterplanes 34 and the screw means 36 comprise a screw 38 with a nut 39, having the threaded body 38a passing through the laminate elements 33 and the through hole 37 when the tightening means 31 are assembled as shown in FIG. 4.

More particularly, the head 40 of the screw 38 and the nut 39 are arranged on opposite sides of the laminate elements 33 that are provided with opposing inner recesses 33a that match the threaded body 38a of the screw 38 when the latter is inserted between them and arranged with the longitudinal axis Z′ parallel to the axis Z defined by the pole P, not illustrated herein.

To tighten the terminal 30 around the pole P, first of all the screw 38 is inserted between the laminate elements 33 and in the through hole 37 of the fork-shaped body 35.

Therefore, by tightening the nut 39 at the end of the threaded stem 38a to projecting from the through hole 37, the underside 40a of the head of the screw 38 is forced against the edge of the laminate elements 33 and the inclined counterplanes 34 of the fork-shaped body 35 are forced against the inclined planes 32.

The situation is thus as shown in FIG. 4, where the force with which the is planes and counterplanes 32 and 34 are forced against one another generates a horizontal component F that moves the counteracting projections 41 of the laminate elements 33 near each other until the tightening operation is completed and the respective plane contact surfaces 41a are in contact with each other.

The action of the counteracting projections will be described in greater detail with reference to FIGS. 6 and 7. The counteracting projections improve the contact between the shaped body 42 and the pole P of the battery. The tightening means 31, however, can be carried out even without the counteracting projections.

As the nut 39 is tightened from above and according to the axis Z of the screw 38 that is parallel to the axis Z of the pole P. the presence of any obstacles at the sides of the terminal 30 does not prevent or hinder the tightening operation.

Furthermore, the nut 39 can always be tightened by means of a socket box wrench and therefore in a quicker and safer way than in the cases where the screw is arranged with horizontal axis and in the presence of lateral obstacles it is necessary to manoeuvre the nut using a fork wrench.

A further construction variant of the terminal that is the subject of the invention is shown in FIG. 5, where it is indicated as a whole by 50 and differs from the construction variant just described only in that in the screw means 56 that make up the tightening means, indicated as a whole by 51, the nut 59 that is coupled with the screw 58 is provided with projections 59a that can be used to carry out the operation manually.

This facilitates the terminal connection and disconnection operation, which can be carried out with no need to use a wrench.

FIGS. 6 and 7 show a top view of a detail of the terminal of the invention shown in FIGS. 3-5 that substantially includes just the shaped body 42 and the laminate elements 33 for tightening the shaped body around the pole P.

The components that are not strictly necessary for explaining the action of the to counteracting projections 41 have been omitted for the sake of simplicity.

As shown in FIGS. 6 and 7, the shaped body 42, substantially having a C-shaped profile suitable for coupling with the pole P of a battery, is provided with laminate elements 33 parallel to each other positioned at the level of the open section 44 that defines the C-shaped profile of the shaped body 42.

The screw 38 passes at the level of the recesses 33a.

Preferably, the diameter of the screw 38 of the tightening means is so small that, once the counteracting projections 41 are in contact with each other, the laminate elements 33 do not touch the screw 38, thus allowing the laminate elements 33 to be moved even nearer each other in proximity to the shaped body 42.

It is clear that, depending on their length, the laminate elements 33 can be associated with several tightening means.

On the side opposite the laminate elements 33, the shaped body 42 is provided with means for connection to the end of one or more electrical wires that are not illustrated herein.

In particular, in the embodiment of the terminal indicated as a whole by I that is shown and described in FIG. 8, the connection means 9 comprise deformable tabs 10 for crimping to the ends of electrical wires that are not illustrated herein.

In a different embodiment of the invention the connection means, instead of comprising deformable tabs for crimping, may comprise auxiliary terminals to be tightened with screws or other systems.

The structure of the shaped body 2 differs from the one shown in FIG. 3 as the two semicircles 3 extend at their meeting point to form two overlapping strips ending in the connection means 9.

However, the most varied types of connections to the shaped body can be conceived.

These connections can vary independently of the execution of the tightening means or of the laminate elements.

According to a construction variant of the invention shown in FIG. 9 the battery terminal, indicated as a whole by 20, has on the shaped body 22 auxiliary connection means 23 for the connection of electrical wires suited to power auxiliary equipment.

According to the invention, at least one of the laminate elements 33 is provided to with counteracting projections 41 suited to cooperate by mutual contact when the tightening means, not illustrated herein, lock the shaped body 42 around the pole P.

In particular, as shown, the counteracting projections 42 are present in both the laminate elements 33 and have the same length 11a.

They are arranged at the end of the laminate elements 33 and therefore downstream of the area where the laminate elements 33 are forced against each other.

It can be noticed that the counteracting projections 41 are spaced from each other of a distance 11b shorter than the distance 11d between the laminate elements 33.

By varying the distance 11b it is possible to modify the force exerted on the shaped body 42 around the pole P.

Furthermore, the counteracting projections 42 are provided with opposing plane contact surfaces 41a to facilitate contact when the projections 41 are mutually joined by screwing the tightening means as explained below.

In practice, to be coupled with the battery pole, the terminal must be initially arranged as shown in FIG. 3, so that it can be slidingly fitted around the pole P.

Tightening is then carried out, so that the inclined planes and counterplanes not represented are mutually forced and move the laminate elements 33 near each other, thus forcing the shaped body 42 circumferentially around the pole P.

When the plane contact surfaces 41a of the counteracting projections 42 come in contact with each other as shown in FIG. 7, the tightening of the nut 39 (not shown) can continue, increasing the circumferential pressure of the shaped body 42 around the pole P while the laminate elements 33 remain substantially parallel.

Furthermore, the tightening means are not subjected to deformation.

Therefore, as shown in FIG. 7, uniform distribution of pressure on the outer surface of the pole P is obtained for the entire extension of the contact surface.

Substantially, and contrary to what happens with the terminals of the known art, the contact between the plane surfaces 41a of the counteracting projections 41 prevents the laminate elements 33 from becoming inclined as shown in FIG. 2 and the surface of the shaped body 42 from detaching from to the outer surface of the pole P.

Advantageously, if the nut 39 were tightened with a torque exceeding the defined value, the laminate elements 33 would tend to move nearer at the level of the open section 44 of the shaped body 42, as shown in FIG. 7, and this would increase the surface in contact with the pole P, thus improving the is electrical contact and increasing the quantity of current that can be transferred. It is therefore clear, according to the above description, that the battery terminal carried out according to the invention effectively achieves all the aims set.

In particular, the battery terminal that is the subject of the invention allows access to the tightening means from above, thus facilitating screwing and loosening of the same.

By providing the laminate elements with counteracting projections ensuring better contact between the pole and the terminal than that provided by equivalent terminals of known type having the same size, which can be done thanks to the terminal of the invention, it is possible to increase the current density and therefore to reduce the losses due to heating and increase the overall efficiency of the electrical connection.

On the basis of the description provided above, it is clear that the battery terminal that is the subject of the invention, in all the construction variants described, achieves the set objects.

It is clear that in the construction stage the battery terminal that is the subject of the invention can be subjected to changes and variants that are not described or illustrated herein, especially concerning the shape of the shaped body, of the connection means and of the tightening means.

Said construction variants must all be considered protected by the present patent, provided that they fall within the scope of the claims expressed below.

In the cases where the technical characteristics illustrated in the claims are followed by references, these have been added only with the aim to facilitate s the comprehension of the claims themselves, and therefore said references do not have any limiting effect on the degree of protection to be granted to each element they identify only by way of example.

1) Battery terminal for electrical connections of the type comprising:
a substantially C-shaped body suitable for coupling with the pole of a battery;
at least two projecting laminate elements parallel to each other, provided at the level of the open section of said C-shaped body;
tightening means associated with said laminate elements for clamping said shaped body around said pole which comprise one pair of inclined planes provided outside said laminate elements, one pair of inclined counterplanes in a fork-shaped body and screw means for mutually forcing the inclined planes and the inclined counterplanes;
connection means associated with said shaped body for connection to the end of one or more electrical wires,
wherein in both said projecting laminate elements there are counteracting projections suited to cooperate by mutual contact when said tightening means lock said shaped body around said pole.

2) Battery terminal according to claim 1), wherein said fork-shaped body is provided with a through hole arranged centrally with respect to said inclined counterplanes.

3) Battery terminal claim 1), wherein said screw means comprise a screw with a nut.

4) Battery terminal according to claim 3), wherein said screw comprises a threaded stem suited to be arranged between said laminate elements and in said through hole of said fork body and of a head whose underside is in contact with said laminate elements of said fork-shaped body when said nut is screwed to the end of said threaded stem projecting from said through hole of said fork-shaped body.

5) Battery terminal according to claim 3) wherein said nut is provided with projections that can be used to carry out the operation manually.

6) Battery terminal for electrical connections according to claim 1), characterized in that wherein said counteracting projections have the same length.

7) Battery terminal for electrical connections according to claim 1), wherein said counteracting projections are spaced from each other of a distance that is shorter than the distance of said projecting laminate elements from each other.

8) Battery terminal for electrical connections according to claim 1), wherein said counteracting projections are present at the end of said laminate elements.

9) Battery terminal for electrical connections according to claim 1), wherein the opposing contact surfaces of said counteracting projections are flat.

10) Battery terminal for electrical connections according to claim 1), wherein said connection means comprise deformable tabs belonging to said shaped body for crimping to the end of electrical wires.
